(19) United States
(12) Patent Application Publication
(10) Pub. No.: US 2012/0126718 A1
(43) Pub. Date: May 24, 2012

(54) LED Array Inspection Fixture

(75) Inventors: Shi-Liang Shan, Chung-Ho (TW); Xiao-Bo Zhu, Chung-Ho (TW); Ching-Feng Hsieh, Wanhua District (TW)

(73) Assignee: Askey Computer Corporation, Chung-Ho (TW)

(21) Appl. No.: 12/962,149

(22) Filed: Dec. 7, 2010

(30) Foreign Application Priority Data
Nov. 18, 2010 (TW) 99139655

(51) Int. Cl. H05B 37/02

(52) U.S. Cl. 315/294

(57) ABSTRACT

An inspection fixture for inspecting an LED array of a circuit board under test through a power supply unit, includes: an inspection base having a testing platform with a plurality of pairs of anode and cathode probes corresponding to anode and cathode pins of the LEDs of the LED array, each pair being electrically connected to the power supply unit to constitute a power supply circuit; a carrier board used for carrying the circuit board under test and having through holes corresponding to the anode and cathode probes; and a pressing member for pressing the circuit board and driving the carrier board to move so as to enable the anode and cathode probes to pass through the through holes and come into contact with the anode and cathode pins of the LEDs, thereby supplying power to each of the LEDs to emit light through the power supply circuit.

### BACKGROUND OF THE INVENTION

1. Field of the Invention

The present invention relates to LED (light emitting diodes) array inspection fixtures.

2. Description of Related Art

Generally, an electronic product such as a computer, a network device or a household appliance has a plurality of LEDs disposed thereon so as to allow the user to learn the operating status of the electronic product and thereby facilitate the user's control of the electronic product. The LEDs are usually arranged in a single LED array on a circuit board. The user can determine the operating status of the electronic product through the action of the LEDs, such as on, off or flashing. Generally, before the electronic product is mass produced or delivered, the LED array of the circuit board of the electronic product is inspected to determine whether the LEDs of the LED array function properly, and if any one of the LEDs malfunctions, the LED array must be replaced.

A common inspection method for an LED array of a circuit board under test is shown in FIG. 1. Referring to FIG. 1, the circuit board 1 has a socket 12 disposed thereon and connected to a chassis 20 of a test device 2, and the chassis 20 has an LED test software (not shown) installed therein such that an inspection command can be sent from the test software through the socket 12 to the circuit board 1. Further, a plug 30 of a power supply 3 is connected to a power socket 13 of the circuit board 1 for supplying power to the circuit board 1 so as to allow an inspection process to be performed. According to the inspection command received through the socket 12, a control chip 10 of the circuit board 1, such as a microprocessor, controls lighting of each LED (110, 111, 112 and 113) of the LED array 11, and the test device 2 displays a user interface (not shown) on a display 21 for the user to perform the inspection process, i.e., sequentially control the LEDs 110, 111, 112 and 113 to emit light so as to determine whether all the LEDs function properly.

However, it is time-consuming to inspect the LEDs one by one. Further, if any one of the LEDs malfunctions, the whole LED array must be replaced with another LED array and the inspection process must be performed again, thereby resulting in high labor cost and time cost.

### SUMMARY OF THE INVENTION

Accordingly, the present invention provides an LED array inspection fixture to overcome the labor and time-consuming drawbacks existing in the conventional LED array inspection process.

In order to achieve the above and other objects, the present invention provides inspection fixture for inspecting an LED array on a circuit board under test through a power supply unit, which comprises: an inspection base comprising a testing platform and a plurality of pairs of anode and cathode probes vertically disposed on the testing platform and corresponding to anode and cathode pins of the LEDs of the LED array, respectively, wherein the inspection base is used for receiving the power supply unit and the power supply unit is electrically connected to lower ends of each of the pairs of anode and cathode probes so as to constitute a power supply circuit in each of the pairs; a carrier board disposed on the inspection base and capable of ascending and descending relative to the testing platform, wherein the carrier board comprises a positioning portion for positioning the circuit board under test and a plurality of through holes corresponding in position to the pairs of anode and cathode probes, respectively; and a pressing member disposed on the inspection base for pressing the circuit board under test and driving the carrier board to descend so as to cause the pairs of anode and cathode probes to pass through the corresponding through holes of the carrier board and come into contact with the anode and cathode pins of the LEDs, respectively, thereby supplying power to each of the LEDs through the power supply circuit constituted by the corresponding pair of anode and cathode probes and the power supply unit so as to cause each of the LEDs to emit light.

Therein, the inspection base can have a standing frame disposed at one end thereof. The standing frame has a driving unit disposed thereon for controlling the movement of the pressing member. The driving unit comprises: a fastening member fastened to the standing frame and having a first coupling end and a first fastening end opposite to the first coupling end and having a tubular portion; a handle having a bending portion, and a pivot end and a holding portion extending from the two ends of the bending portion, respectively, wherein the pivot end is pivotally connected to the first coupling end of the fastening member; an operating rod having a second pivot end penetrating through the tubular portion and a second fastening end opposite to the second pivot end and fastened to an end surface of the pressing member; and a link member having one end pivotally connected to the bending portion of the handle and the other end pivotally connected to the second pivot end of the operating rod penetrating through the tubular portion.

The inspection base can further have a control switch for switching on or off the power supply circuit so as to enable or disable power supply for driving the LEDs to emit light.

According to the inspection fixture of the present invention, since each pair of anode and cathode probes and the power supply unit constitutes a power supply circuit, when the pairs of anode and cathode probes come into contact with the corresponding anode and cathode pins of the LEDs of an LED array on a carrier board under test, power is supplied to each of the LEDs through the power supply circuit constituted by the corresponding pair of anode and cathode probes and the power supply unit so as to drive each of the LEDs to emit light. As such, the LEDs of the LED array can be inspected at one time so as to save the inspection time and improve the inspection efficiency.

### BRIEF DESCRIPTION OF DRAWINGS

FIG. 1 is a schematic view of a conventional system architecture for performing an inspection process to an LED array on a circuit board;

FIG. 2 is a perspective view of an LED array inspection fixture of the present invention;

FIG. 3A is a cross-sectional view illustrating the positional relationship between a circuit board under test having an LED array and the carrier board, pressing member and testing platform of the inspection fixture of the present invention;

FIG. 3B is a locally enlarged cross-sectional view of the inspection fixture with the circuit board under test disposed on the carrier board and pressed by the pressing member; and

FIG. 4 is a perspective view of a carrier board with a light cover according to an embodiment of the present invention.

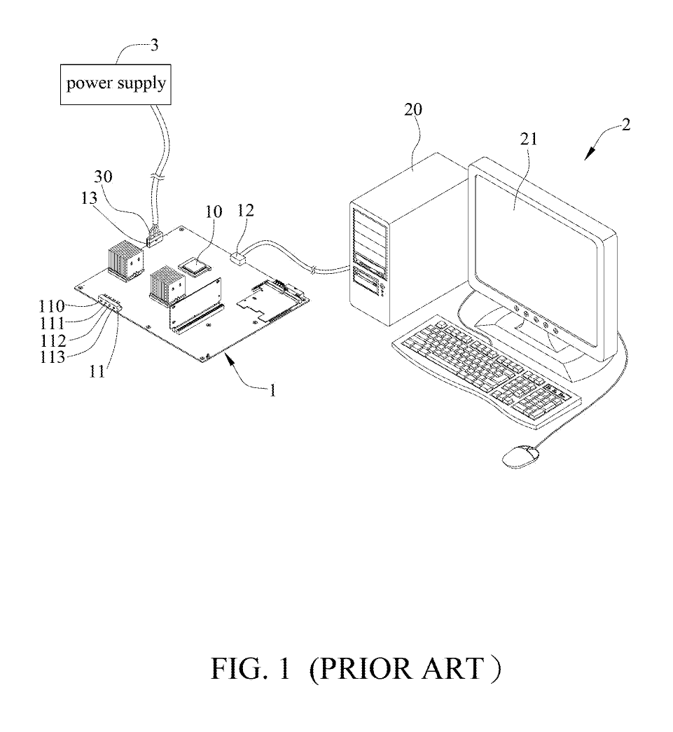

### DETAILED DESCRIPTION OF PREFERRED EMBODIMENTS

The following embodiments are provided to illustrate the present invention. Those skilled in the art will readily understand other advantages and functions of the present invention in accordance with the contents disclosed in this specification. The present invention can also be performed or applied by other different embodiments. Various modifications and variations based on different viewpoints and applications can be made in the details of the specification without departing from the spirit of the present invention.

It should be noted that the drawings are simplified schematic diagrams and only show components relating to the present invention. In practice, the layout of the components may be far more intricate.

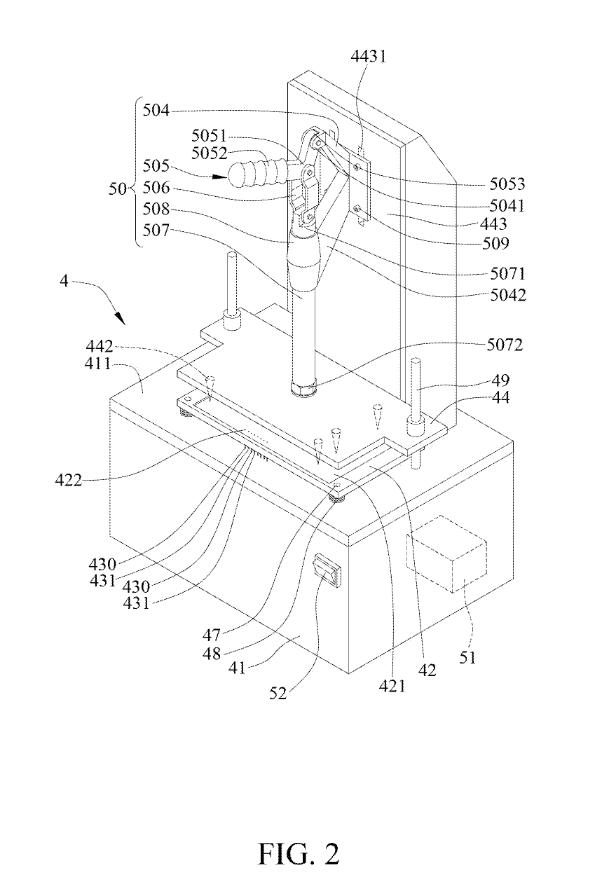

FIG. 2 is a perspective view of an inspection fixture according to the present invention. Referring to the drawing, the inspection fixture 4 is used for inspecting an LED array on a circuit board under test (not shown) through a power supply unit 51, thereby quickly identifying LEDs that fail to emit light or fail to emit sufficient light.

The inspection fixture 4 at least comprises: an inspection base 41, and a carrier board 42 and a pressing member 44 disposed on the inspection base 41.

Therein, the inspection base 41 comprises a testing platform 411 disposed on a surface thereof and a plurality of pairs of anode and cathode probes 430, 431 vertically disposed on the testing platform 411 and corresponding to anode and cathode pins of the LEDs of the LED array, respectively. The inspection base 41 can have a case structure with the power supply unit 51 received therein. The power supply unit 51 is electrically connected to lower ends (not shown) of each of the pairs of anode and cathode probes so as to constitute a power supply circuit in each of the pairs. The lower ends of each of the pairs of anode and cathode probes 430, 431 electrically connected to the power supply unit 51 can be embedded in the inspection base 41.

A plurality of return springs 48 is disposed on the testing platform 411, and a plurality of sliding members 47, 49 for the carrier board 42 and the pressing member 44, respectively, are vertically disposed on the testing platform 411. The functions thereof will be detailed later.

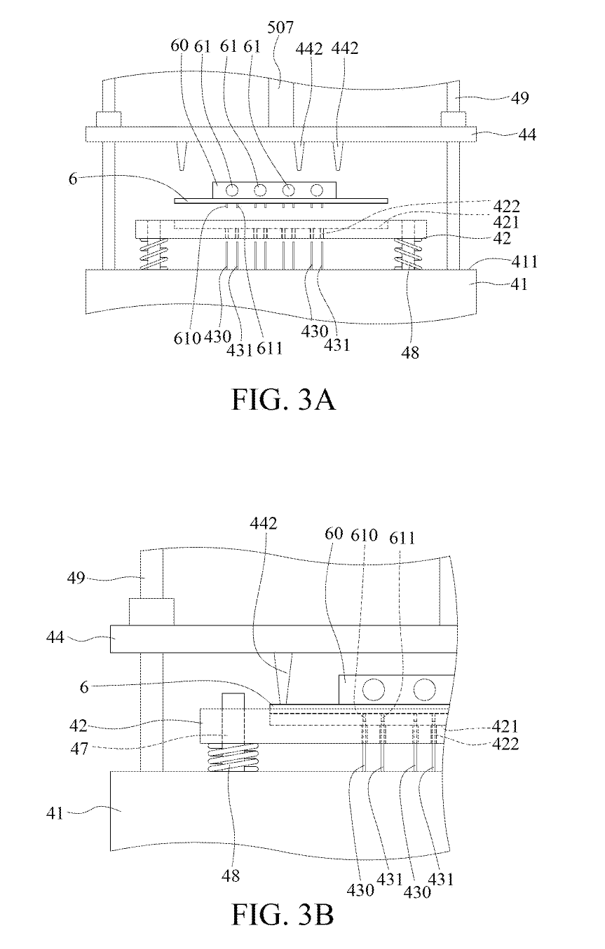

The carrier board 42 is used for carrying the circuit board under test. The carrier board comprises a plurality of through holes 422 corresponding in position to the pairs of the anode and cathode probes 430, 431, respectively, and a positioning portion for positioning the circuit board under test. In the present embodiment, the positioning portion is a recess 421 (referring to FIG. 3A) for receiving and positioning the circuit board under test, and the through holes 422 are disposed in the recess 421. The carrier board 42 is slidingly disposed on the testing platform 411 through the sliding members 47 so as to be capable of ascending and descending relative to the testing platform 411. Further, the return springs 48 can support the carrier board 42 over the testing platform 411. The return springs 48 can provide return forces to the carrier board 42. Furthermore, the sliding members 47 can be disposed to penetrate through the return springs 48 in the axial direction, respectively.

The pressing member 44 is slidingly disposed on the inspection base 411 through the sliding members 49 and comprises a plurality of pins 442 disposed on a surface facing the carrier board 42 such that when the pressing member 44 is pressed down towards the circuit board under test on the carrier board 42, the pins 442 can stably secure the circuit board under test on the carrier board 42.

The inspection base 41 further comprises a standing frame 443 with a driving unit 50 fastened thereon. The driving unit 50 comprises a fastening member 504, a handle 505, an operating rod 507 and a link member 506. Therein, the fastening member 504 is fastened to the standing frame 443 and comprises a first coupling end 5041 and a first fastening end 5042 opposite to the first coupling end 5041 and having a tubular portion 508. The handle 505 comprises a bending portion 5051, and a pivot end 5053 and a holding portion 5052 extending from the two ends of the bending portion 5051, respectively, wherein the pivot end 5053 is pivotally connected to the first coupling end 5041 of the fastening member 504. The operating rod 507 has a second pivot end 5071 penetrating through the tubular portion 508 and a second fastening end 5072 opposite to the second pivot end 5071 and fastened to an end surface of the pressing member 44, wherein the second pivot end 5071 faces the handle 505 and can freely move through the tubular portion 508. The link member 506 has one end pivotally connected to the bending portion 5051 of the handle 505 and the other end pivotally connected to the second pivot end 5071 of the operating rod 507 penetrating through the tubular portion 508. The handle 505 substantially has a V-shape and the holding portion 5052 of the handle 505 is provided for an inspector to hold so as to control the pressing member 44 to ascend or descend relative to the testing platform 411.

The standing frame 443 further comprises a position-limiting slot 4431 longitudinally extending along the standing frame 443, and the fastening member 504 is fastened in the position-limiting slot 4431 through a plurality of screws 509. As such, the fastening member 504 can be fastened to the standing frame 443 at a different height position through the position-limiting slot 4431.

To perform an inspection process to the LED array of the circuit board under test, the handle 505 is pulled towards the testing platform 411 to cause the link member 506 to moved towards the testing platform 411 along with the bending portion 5051 of the handle 505, thereby guiding the operating rod 507 to move towards the testing platform 411. As such, the pressing member 44 is moved close to the testing platform 411 so as to press against the carrier board 42, thereby compressing the return springs 48 and causing the pairs of the anode and cathode pins 430, 431 to pass through the through holes 422 of the carrier board 42 so as to come into contact with the anode and cathode pins of the LEDs of the LED array, respectively. Through the power supply circuit constituted by each of the pairs of anode and cathode probes 430, 431 and the power supply unit 51, each of the LEDs can receive power to emit light, thereby allowing the inspector to identify LEDs that fail to emit light or fail to emit sufficient light.

On the other hand, when the handle 505 is moved away from the testing platform 411, the link member 506 is also moved away from the testing platform 411 along with the bending portion 5051 of the handle 505 so as to guide the operating rod 507 to move towards the handle 505, thereby causing the pressing member 44 to move away from the testing platform 411. As such, the carrier board 42 is moved upwards by the return forces of the return springs 48, thereby separating the anode and cathode pins of the LEDs on the circuit board under test from the corresponding pairs of anode and cathode probes 430, 431.

FIGS. 3A and 3B illustrate the operation relationship between the carrier board 42, the pressing member 44 and the testing platform 411, wherein FIG. 3A is a cross-sectional view illustrating the relationship between the circuit board 6, the carrier board 42, the pressing member 44 and the testing platform 411, and FIG. 3B is a locally enlarged cross-sectional view of the inspection fixture with the circuit board 6 disposed on the carrier board 42 and pressed by the pressing member 44. Referring to FIGS. 3A and 3B, when pressed by the operating rod 507 of the driving unit 50, the pressing member 44 descends relative to testing platform 411 along with the carrier board 42. Since the through holes 422 of the carrier board 42 correspond to the pairs of anode and cathode probes 430, 431, respectively, when the operating rod 507 is moved through operation of the handle 505 so as to cause the pressing member 44 along with the carrier board 42 to move towards the testing platform 411, the pairs of anode and cathode probes 430, 431 protrude from the through holes 422 so as to come into contact with the anode and cathode pins 610, 611 of the LEDs 61 of the LED array 60, respectively, thereby supplying power to each of the LEDs through the power supply circuit constituted by each of the pairs of the anode and cathode probes 430,431 and the power supply unit 51 so as to cause each of the LEDs to emit light.

To facilitate the inspector to identify whether the light brightness of each of the LEDs 61 meets the requirement, a good sample and a defective sample (not shown) can further be disposed on the testing platform 411 of the inspection base 41 for comparison. Each of the LEDs can be compared with the good sample and the defective sample for determining whether the light brightness of the LED meets the requirement or not.

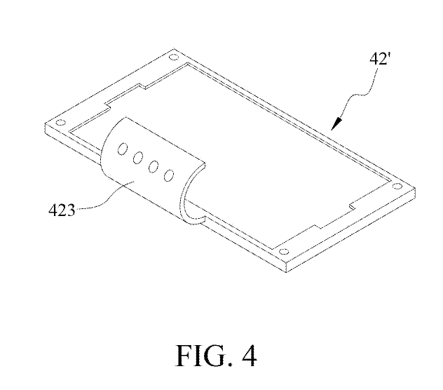

In addition, a light cover can be disposed on the carrier board to cover the LED array, as shown in FIG. 4. The carrier board 42′ and the light cover 423 can be integrally formed. The light cover 423 is used to simulate the lighting state of the LED array when it is disposed in a product case. Furthermore, the light cover can be pivotally connected to the carrier board.

Referring again to FIG. 2, the inspection base 41 can further comprise a control switch 52 for switching on or off the power supply circuit in each of the pairs of anode and cathode probes 430, 431 and the power supply unit 51, thereby enabling or disabling power supply for driving the LEDs to emit light.

According to the present invention, the circuit board under test is disposed on the carrier board and secured by the pressing member, and the plurality of through holes of the carrier board allows the anode and cathode probes to protrude therefrom so as to come into contact with the corresponding anode and cathode pins of the LEDs of the LED array on the circuit board under test. As such, the LEDs of the LED array can be inspected at one time, thus saving the inspection time and reducing the labor cost.

The above-described descriptions of the detailed embodiments are intended to illustrate the preferred implementation according to the present invention but are not intended to limit the scope of the present invention. Accordingly, all modifications and variations completed by those with ordinary skill in the art should fall within the scope of present invention defined by the appended claims.

What is claimed is:

1. An inspection fixture for inspecting an LED array on a circuit board under test through a power supply unit, comprising:
an inspection base comprising a testing platform and a plurality of pairs of anode and cathode probes vertically disposed on the testing platform and corresponding to anode and cathode pins of LEDs of the LED array, respectively, wherein the inspection base is used for receiving the power supply unit and the power supply unit is electrically connected to lower ends of each of the pairs of anode and cathode probes so as to constitute a power supply circuit in each of the pairs;
a carrier board disposed on the inspection base and capable of ascending and descending relative to the testing platform, wherein the carrier board comprises a positioning portion for positioning the circuit board under test and a plurality of through holes corresponding in position to the pairs of anode and cathode probes, respectively; and
a pressing member disposed on the inspection base for pressing the circuit board under test and driving the carrier board to descend so as to cause the pairs of anode and cathode probes to pass through the corresponding through holes of the carrier board and come into contact with the anode and cathode pins of the LEDs, respectively, thereby supplying power to each of the LEDs through the power supply circuit constituted by the corresponding pair of anode and cathode probes and the power supply unit so as to cause each of the LEDs to emit light.

2. The fixture of claim 1, wherein the carrier board has a light cover disposed thereon for covering the LED array.

3. The fixture of claim 2, wherein the light cover is pivotally disposed on the carrier board.

4. The fixture of claim 1, further comprising a plurality of sliding members vertically disposed on the testing platform and penetrating through the carrier board for allowing the carrier board to ascend and descend relative to the testing platform.

5. The fixture of claim 1, wherein the carrier board further has a plurality of return springs disposed thereon for supporting the carrier board over the testing platform and providing return forces to the carrier board.

6. The fixture of claim 1, wherein the pressing member has a plurality of pins disposed on a surface facing the carrier board such that when the pressing member is pressed down towards the circuit board under test on the carrier board, the pins secure the circuit board under test on the carrier board.

7. The fixture of claim 1, wherein the inspection base has a standing frame disposed at one end thereof, and the standing frame has a driving unit disposed thereon for controlling the movement of the pressing member, wherein the driving unit comprises:
a fastening member fastened to the standing frame and having a first coupling end and a first fastening end opposite to the first coupling end and having a tubular portion;
a handle having a bending portion, and a pivot end and a holding portion extending from the two ends of the bending portion, respectively, wherein the pivot end is pivotally connected to the first coupling end of the fastening member;
an operating rod having a second pivot end penetrating through the tubular portion and a second fastening end opposite to the second pivot end and fastened to an end surface of the pressing member; and
a link member having one end pivotally connected to the bending portion of the handle and the other end pivotally connected to the second pivot end of the operating rod penetrating through the tubular portion.

8. The fixture of claim 1, wherein the inspection base further has a control switch for switching on or off the power supply circuit so as to enable or disable power supply for driving the LEDs to emit light.

9. The fixture of claim 1, wherein the positioning portion of the carrier board is a recess and the through holes of the carrier board are formed in the recess.

10. The fixture of claim 1, wherein the inspection base further has a good sample and a defective sample for comparison with each of the LEDs of the LED array to determine whether light brightness of each of the LEDs meets requirements or not.
